(19) United States
(12) Patent Application Publication
(10) Pub. No.: US 2010/0185965 A1
(43) Pub. Date: Jul. 22, 2010

(54) Artistic file manager

(76) Inventors: Frederick Collin Davidson, Apex, NC (US); Edward O'Brien Wolf, Fairport, NY (US); Richard Krueger, Cary, NC (US); Guy Richard Beretich, JR., Clinton, NC (US); Pliny Allen Porter, IV, Los Angeles, CA (US)

Correspondence Address: Richard Krueger, 106A Fountainbrook Circle, Cary, NC, 27511, US

(21) Appl. No.: 12/321,450

(22) Filed: Jan. 21, 2009

(51) Int. Cl. G06F 3/048

(52) U.S. Cl. 715/765; 715/766

(57) ABSTRACT

A file manager for a consumer electronic device enhances a user's experience in a computing environment by displaying a variety of content in a folder in a collage configuration. The content may be, for example, live applications and other files, and are collectively termed assets. The file manager also displays the content in a grid configuration for management purposes, and provides graphics tools to allow the user to artistically customize the display of the assets.

### TECHNICAL FIELD

The present invention relates generally to computers and computer-related technology. More specifically, the present invention relates to systems and methods for managing files.

### BACKGROUND

A file manager or file browser is a computer program that provides a user with an interface to work with file systems. Generally, the interface is a Graphical User Interface (GUI) that provides a graphical representation of the files stored on a computer. With a GUI, the user may, inter alia, launch programs for execution and perform a variety of operations on the files. Some of the most common operations on files include create, open, edit, view, print, play, rename, move, copy, and delete. Additionally, file managers typically allow the user to view and monitor file attributes, properties, and permissions, as well as to search for files stored on the computer.

One newer type of file manager is termed a “navigational file manager.” Navigational file managers became prominent with users due to the popularity of the MICROSOFT WINDOWS operating system. Navigational file managers use a “navigational” metaphor to represent file system locations and are often referred to as “Explorer” type of file managers. One classic navigational file manager is the WINDOWS EXPLORER provided with the WINDOWS operating system.

Since the advent of the GUI, navigational file managers have become the dominant type of file managers for desktop computers. For example, most, if not all, MICROSOFT WINDOWS products such as applications use a navigational file manager to facilitate user interaction. Typically a navigational file manager displays a window comprising two asymmetrical panes. A first pane, which is usually on the left-hand side of the window, includes icons that provide the user with a graphical representation of the filesystem. Generally, the icons in the first window are displayed in a tree-like structure to hierarchically represent the filesystem. The second pane, which is typically on the right-hand side of the window, includes one or more icons that represent the files and subdirectories of the current directory. The user can launch application programs or display the contents of subdirectories by clicking on the appropriate icons. When the user selects a directory from the tree in the first pane, it becomes the current directory. The icons in the second pane then changes to display the files and subdirectories of the selected directory. APPLE'S MAC OS X is another type of operating system that uses a navigational file manager called “FINDER.”

An interface in a navigational file manager often resembles a web browser. Therefore, navigational file managers usually include a variety of control buttons such as back, forward, and reload. In many cases, navigational file managers also include an address bar or address field. The user can manually enter a Universal Resource Location (URL) into this field to directly access a directory or file. Users may also perform “drag-and-drop” operations to move the contents of one directory to another different directory. Additionally, users can select and copy files or directories from one navigational file manager window into a clipboard, and then paste them in another directory. Thus, a user need not open different windows to move files between locations. In addition, several instances of a navigational file manager can be opened simultaneously. In these cases, the user can perform the drag-and-drop operations, as well as the cut/copy and paste operations, to move files and directories between completely different instances of navigational file managers.

Another type of file manager is called a spatial file manager. Spatial file managers employ a spatial metaphor to represent files and folders as if they are real physical objects. A spatial file manager imitates the way people interact with the physical objects. With spatial file managers, a single window represents each opened folder. Each window is unambiguously and irrevocably tied to a particular folder. Further, all files, folders, and windows exhibit stability, in that they go where the user moves them, and stay where the user puts them. Thus, these objects preserve their spatial state and retain their “physical” characteristics, such as size, shape, color and location. Additionally, a given file or folder can only be viewed in one window at a time.

As with navigational type file managers, when a folder is opened in a spatial file manager, the icon representing the folder changes. By way of example, an icon associated with a particular file may change from an image showing a closed drawer to an image of an open drawer when the user opens the document. In another example, when a user desires to open a directory, the folder's icon may change to a silhouette filled with a pattern, and a new window is opened. Some examples of operating systems that use spatial file managers include, Finder in APPLE'S pre-OS X versions of the MAC OS, the Reduced Instruction Set Computer's (RISC) OS Filer, AMIGA'S Workbench, GNOME's Nautilus, KONQUEROR, and BeOS's Tracker. The earlier versions of MICROSOFT'S WINDOWS Explorer distributed with Windows 95 were spatial file managers, as was DIGITAL RESEARCH'S Graphical Environment Management (GEM), which was implemented in Atari's The Operating System (TOS) and in Personal Computers (PCs), and ZDESKTOP and FILEMAGE Zoomable File-System Viewers.

While these file managers provide the ability to navigate and manage files easily, they are viewed as strictly utilitarian by some users. Therefore, a need exists to enhance the user experience while using a file manager.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates a file manager window in one embodiment of the present invention, wherein the file manager is configured to display assets in a collage configuration.

FIG. 2 illustrates a file manager window in one embodiment of the present invention, wherein the file manager is configured to include graphics.

FIG. 3 illustrates a file manager window in one embodiment of the present invention, wherein the file manager is configured to display assets in a grid configuration.

FIG. 4 is a block diagram illustrating some of the component parts of a computing device configured with a file manager according to one embodiment of the present invention.

FIG. 5 is a block diagram illustrating a peer-to-peer network having interconnected nodes configured according to one embodiment of the present invention.

### DETAILED DESCRIPTION

The present invention is directed toward a file manager that enhances the user experience in a computing environment by displaying live applications, which are applications that are currently executing, and other folder content in a collage configuration. As used herein, the folder contents are collectively referred to as assets and include, but are not limited to, applications, subfolders, and files such as documents, images, audio, video, and other multimedia files. The collage configuration is one that permits non-restricted positioning of these assets in the X and Y planes of the folder. That is, unlike most conventional file managers, a user can position an asset anywhere on a display screen and is not restricted to predetermined positions.

Additionally, in the collage configuration, a user may superimpose one asset over another in a “Z-order.” A “Z-order” is an ordering of overlapping two-dimensional objects such as assets along a Z-axis. For example, GUIs typically allow a user to open multiple windows on a desktop. With typical GUIs, these windows may overlap so that one window hides part or all of another window. When two windows overlap, their Z-order determines which one appears on top of the other. With the present invention, the icons representing assets may also be placed in a Z-order. Thus, the assets may be ordered from “front to back” along the Z-axis of a window. Users may “click” on a given asset to bring that asset to the front. The user can also change the order of the assets in the z-plane.

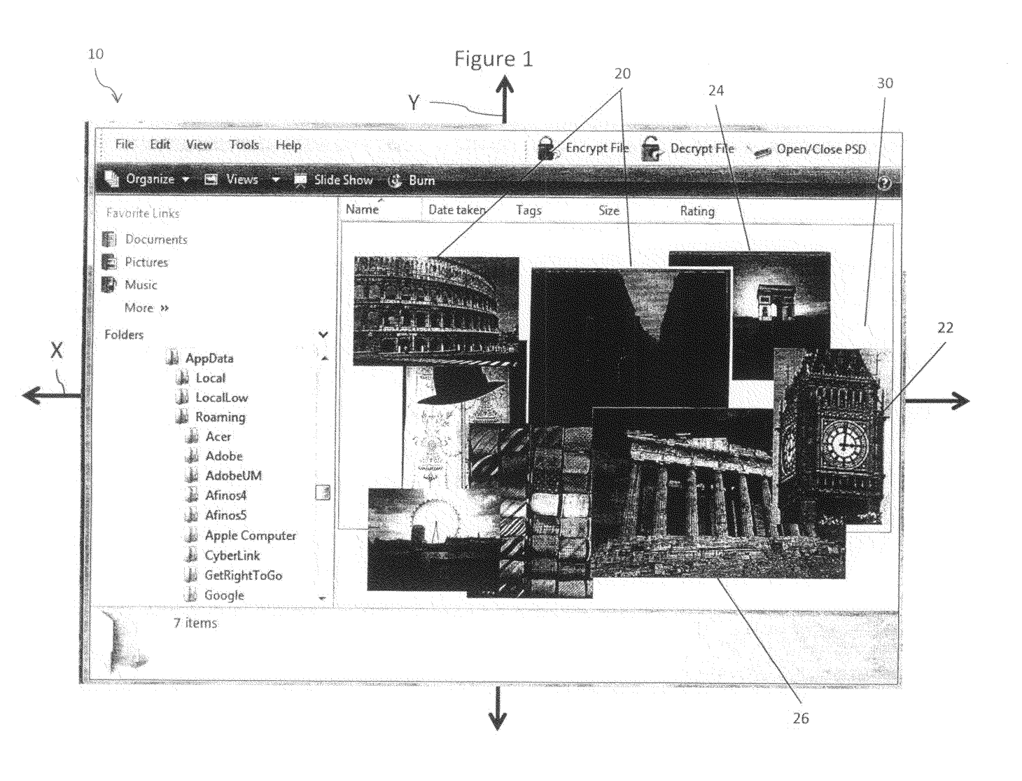

Therefore, the present invention allows a user to arrange assets such as files in a folder, for example, in a collage configuration, wherein the spatial positions and orientations of the assets in the folder are adjustable to permit artistic expression. An example is shown in FIG. 1. In the example, a file manager output window, generally described as 10, displays one or more two-dimensional icons 20 artistically arranged in non-predetermined positions in the x- and y-planes and z-order of a panel 30. In this embodiment, the icons 20 are shown as images, each representing a different asset. Each icon 20 comprises a 32-bit RGBA composite image that can be translucent or semi-transparent. However, those skilled in the art will appreciate that the use of icons 20 is for illustrative purposes only. The assets may be represented by any means known in the art.

The present invention also includes functionality that permits a user to use a variety of graphical tools to customize the output window 10. For example, a user can modify the panel 30 by changing its color, texture, pattern or the like, or by setting an image or other visual file as a background for the panel 30. The user can also employ graphical tools such as a brush, pen, pencil, crayon, and the like, to add artistic color and/or textual effects over the collage arrangement. Thus, the file manager functions as an artistic file manager that graphically arranges or organizes icons associated with a user's stored assets, while permitting the user to embellish or otherwise artistically modify the icons as well as the space that contains the icons.

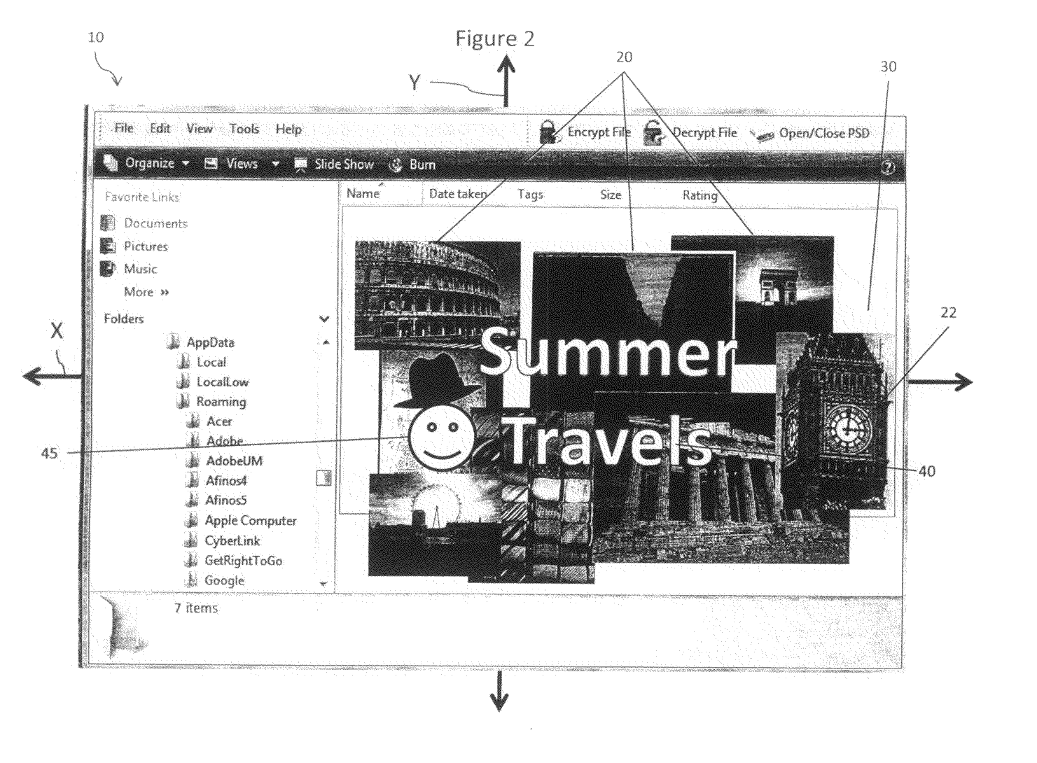

FIG. 2, for example, illustrates an example of how a user might use one embodiment of the present invention to artistically arrange or customize a plurality of icons 20, as well as panel 30. In this embodiment, the user has arranged the icons 20 within the x-y plane. This may be accomplished, for example, by “dragging and dropping” a given icon 20 to a desired space within the panel 30. Additionally, the user may set and alter the “z-order” of the icons 20. Particularly, the icons 20 may be arranged within panel 30 such that some icons are displayed “in the front” of the panel 30 and overlap other icons “in the back” of panel 30. As seen in FIG. 2, for example, icon 22 overlaps or is in front of icons 24 and 26.

Further, a user may add a variety of graphics to panel 30 using any graphics tools known in the art. In FIG. 2, for example, a user has placed text 40 and an image 45 within the panel 30 such that they are on top, or in front, of the icons 20 in the panel 30. The text and/or images 40, 45 may be descriptive of the types of assets displayed within the panel 30 to allow a user to easily distinguish which folder he is viewing.

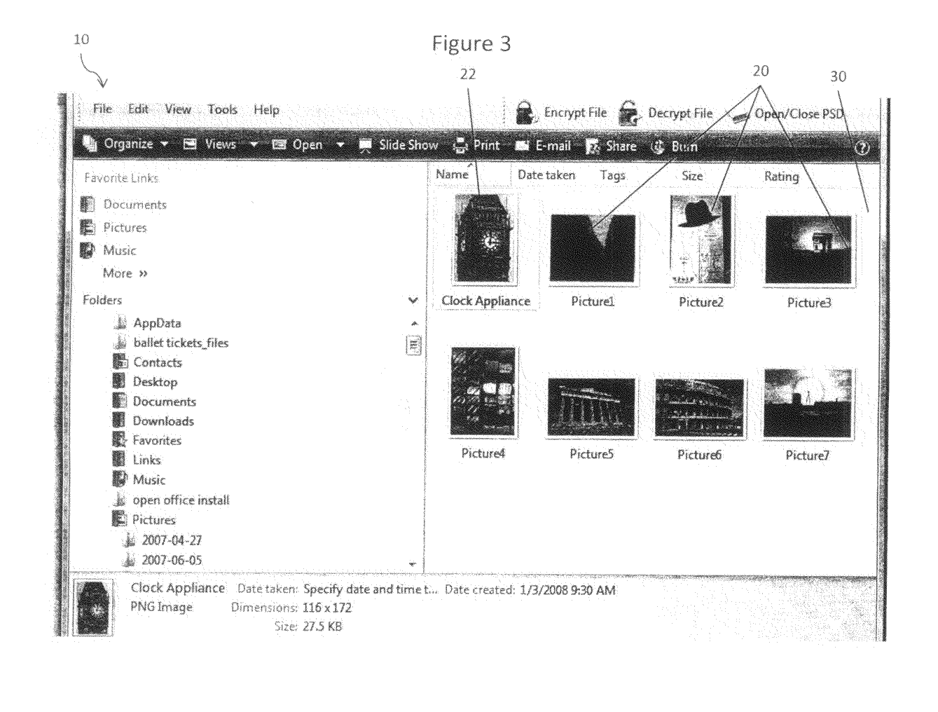

While the artistic modification of a file manager can greatly enhance a user's experience, at times it may be desirable to view the assets of a folder in an organized fashion for the purposes of file management, including inventory, selection, deletion, and the like. As seen in FIG. 3, for example, the file manager may be configured to display the icons 20 in the output window 10 as a grid. In this embodiment, the grid aligns a plurality of icons 20 in a predetermined column-row pattern in panel 30. With the grid view, the present invention aligns the icons 20 such that they are not superimposed over each other and are clearly distinguishable.

Graphically, the grid view can comprise any of the classic views of WINDOWS Explorer, such as tile view, detail view, list view, icon view, thumbnail view, and the like. However, the grid view may include any predetermined alignment pattern, including but not limited to, mosaic patterns and designs and artistic geometric or mathematical patterns such as Fibonacci spirals, pyramids, and the like.

FIG. 3 illustrates a grid view of the icons 20 shown in FIGS. 1 and 2. In this embodiment, the icons 20 comprise thumbnail images of the assets, which comprise a variety of different files. The icons 20 are arranged in an orthogonal fashion with the names of their corresponding files listed below each icon 20. In this embodiment, artistic embellishments such as the added text and pictures are not shown; however, those of ordinary skill in the art will readily appreciate that such graphics may be present in an alternative embodiment.

In addition to enhancing user experience, the ability of a file folder according to the present invention to also perform as an artistic collage space eliminates the need to keep a copy of an asset in both the artistic collage program and a separate storage file folder. In this manner, the present invention can reduce storage requirements for artistic assets.

The present invention can further include the ability to execute software applications within the file manager. For example, the clock tower icon 22 shown in FIGS. 1, 2 and 3 is associated with a software application that can run within the file manager, displaying the time. Thus, the file manager of the present invention is a dynamic file manager that can display live software applications executing while the user is viewing or editing the folder.

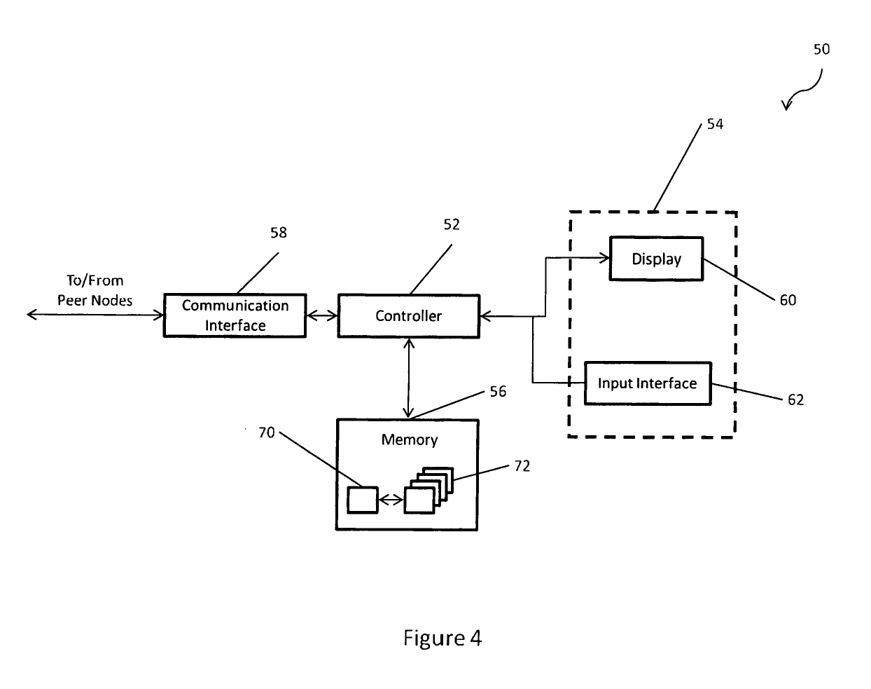

FIG. 4 illustrates some of the components of a computing device 50 configured to function according to one embodiment of the present invention. As seen in FIG. 4, the computing device 50 comprises a node capable of communicating in a peer-to-peer network. Some examples of nodes that are suitable for use with the present invention include, but are not limited to, mobile communication devices such as cellular telephones, satellite telephones, and Personal Digital Assistants (PDAs), as well as laptop computers, notebook computers, and desktop computers.

Computing device 50 comprises a controller 52 that connects to a user interface 54, a memory 56, and a communication interface 58. Controller 52 comprises one or more microprocessors that control the operation of device 10 according to program instructions and data stored in memory 56. The control functions may be implemented in a single microprocessor, or in multiple microprocessors. Memory 56 may include both random access memory (RAM) and read-only memory (ROM). Executable program instructions and data required for operation of device 50 are stored in non-volatile memory, such as EPROM, EEPROM, and/or flash memory, which may be implemented as discrete or stacked devices, for example. Communication interface 58 is configured to communicate with other peer nodes via a peer-to-peer network, or with other communication terminals, using any protocol known in the art. User interface 54 comprises a display 60 and an input interface 62 to receive user input.

Memory 56 may store a file manager application 70 and one or more assets 72. In this embodiment, the assets 72 comprise one or more files arranged in one or more folders and are represented to the user by icons 20. The file manager application 70 configures the controller 52 to output window 10 to display 60. Using the interface 62, the user may customize the output window 10 to arrange the icons 20 within the x-y plane, as well as define their z-order, as previously described.

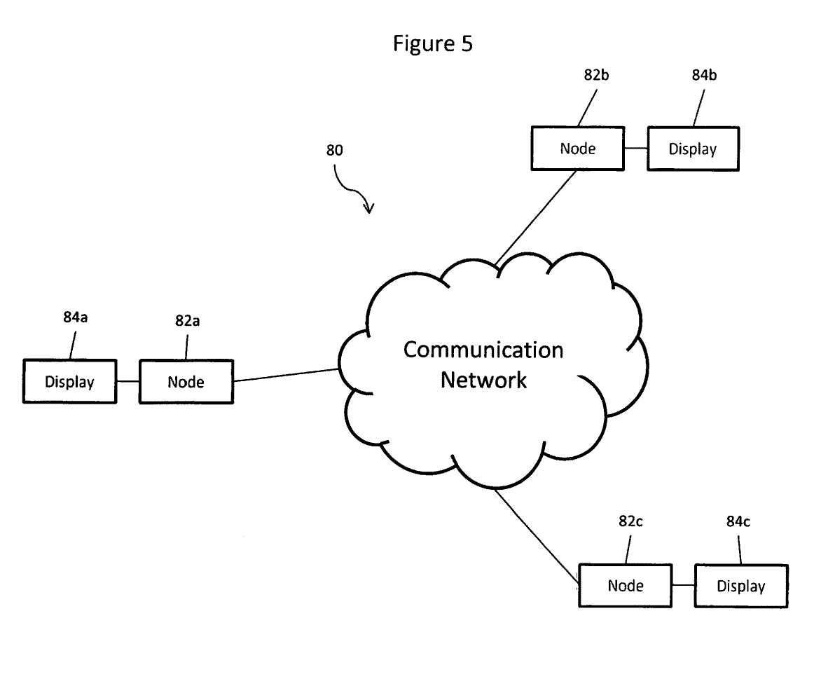

As seen in FIG. 5, the present invention further includes the use of the file manager application 70 in a peer-to-peer network 80. To date, peer-to-peer networks have only been used for sharing assets 72 among peer nodes 82. In the present invention, however, a file manager application 70 could execute on each node 82b, 82c to replicate the output window 10 of a first node 82a. Particularly, the file manager application 70 executing on each node 82b, 82c might output a window 10 on respective displays 84b, 84c. The windows 10 could display the icons 20 associated with assets 72 stored on node 82a as arranged by the user of node 82a. Thereafter, any changes or updates made by a user of node 82a to the positioning of icons 20 in the x, y plane and the z-order could be propagated to the other nodes 82b, 82c.

The ability to personalize or otherwise artistically modify a file manager in a peer-to-peer network will enhance the user experience. This aspect of the present invention, along with the ability to organize assets, is especially valuable in a peer-to-peer network, where transmitting assets between nodes can be time-consuming. Thus, the users in a peer-to-peer network can both share assets in a normal manner as well as express themselves artistically with the program.

The present invention further includes the collaborative use of the file manager in a peer-to-peer space. In this embodiment of the present invention, users can use the graphics tools to modify one another's folders, thus permitting collaborative artistic expression in each other's folders and thereby enhancing user experience.

The present invention may, of course, be carried out in other ways than those specifically set forth herein without departing from essential characteristics of the invention. The present embodiments are to be considered in all respects as illustrative and not restrictive.

We claim:

1) A file manager for the management of at least one folder, the folder comprising a background and at least one asset; the file manager providing a collage folder configuration that provides for non-restricted positioning of the at least one asset in the X and Y planes of the folder and the superimposing of the at least one asset over a second asset in the Z-order; the file manager further providing for switching between the collage folder configuration and a predetermined alignment pattern configuration that provides an organized display of the at least one asset for the purposes of file management.

2) The file manager of claim 1, wherein the at least one asset is represented by 32-bit RGBA composite images.

3) The file manager of claim 1, wherein the file manager provides graphical tools to customize the collage folder configuration.

4) The file manager of claim 3, wherein the graphical tools are selected from the group consisting of a brush, pen, pencil and crayon.

5) The file manager of claim 3, wherein the graphical tools provide for the modification of the background by changing a property selected from the group consisting of color, texture and pattern.

6) The file manager of claim 3, wherein the graphical tools provide for the setting of an image as a background for the panel.

7) The file manager of claim 1, wherein the predetermined alignment pattern is selected from the group consisting of tile view, detail view, list view, icon view, and thumbnail view.

8) The file manager of claim 1, wherein the predetermined alignment pattern is selected from the group consisting of grid patterns, mosaic patterns, mosaic designs, geometric patterns and mathematical patterns.

9) The file manager of claim 1, wherein the file manager provides for the ability to execute software applications within the at least one folder.

10) The file manager of claim 1, wherein the file manager provides for sharing the at least one folder between nodes on a network.

11) The file manager of claim 10, wherein the file manager provides for collaborative customization of the at least one folder in a peer-to-peer network.

12) A system for sharing a customizable folder on a network, the system comprising a network with at least two nodes, each node running a file manager that provides for the management of at least one folder comprising a background and at least one asset, the file manager providing a collage folder configuration that provides for non-restricted positioning of the at least one asset in the X and Y planes of the folder and the superimposing of the at least one asset over a second asset in the Z-order; the file manager further providing for switching between the collage configuration and a predetermined alignment pattern configuration that provides an organized display of the at least one asset for the purposes of file management; and the file manager further providing for sharing the folder between the nodes on the network.

13) The file manager of claim 12, wherein the file manager provides for the collaborative customization of the at least one folder in the network.

14) The system of claim 12, wherein the network comprises mobile communication devices such as cellular telephones, satellite telephones, and Personal Digital Assistants.

15) The system of claim 12, wherein the file manager provides graphical tools to customize the collage folder configuration.

16) The system of claim 15, wherein the graphical tools are selected from the group consisting of a brush, pen, pencil and crayon.

17) The system of claim 12, wherein the file manager provides for the ability to execute software applications within the folder.
